(19) United States
(12) Patent Application Publication
(10) Pub. No.: US 2006/0182836 A1
(43) Pub. Date: Aug. 17, 2006

(54) Extruder for the production of spheroidal or spheroid particles

(75) Inventors: Alexandre Gil, Mougins (FR); Marc Dany Ouattara, Pessac (FR); Laurent Bertocchi, Sylvains Les Moulins (FR)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Ethypharm, Houdan (FR)

(21) Appl. No.: 10/544,900

(22) PCT Filed: Feb. 9, 2004
(86) PCT No.: PCT/FR04/00291

§ 371 Date: Feb. 27, 2006

(30) Foreign Application Priority Data
Feb. 14, 2003 (FR) 03/01,814

(51) Int. Cl. B29B 9/06

(52) U.S. Cl. 425/313

(57) ABSTRACT

The invention relates to an improved extruder for the production of spheroidal or spheroid particles. The inventive extruder consists of a cutting tool comprising knives which take the form of a rectangular blade having first and second flat parallel faces. The aforementioned blade takes the form of a knife owing to a recess which is provided on one of the faces thereof. The recess is only provided on one part of the face in question, such that one of the long sides of said face comprises a narrow flange. Moreover, the two faces of the blade are connected by an inclined surface which extends between the non-recessed face and the narrow flange, the edge of which is used to cut the extruded profile. The extruder also comprises an extrusion die consisting of a ring piece and a cylindrical cap having an axis. One of the ends of the aforementioned cap comprises a collar by means of which the cap is applied against the ring piece, while the other end thereof is closed with a truncated-cone-shaped wall, the conical part of which forms an angle α with a plane which is perpendicular to the axis.

The subject of the invention is an extruder of the kind which allow the manufacture of spheroidal or spheroid particles intended for the pharmaceutical and agri-foodstuffs industries without there being any need to resort to a spheronization step after extrusion.

The spheroidal particles in question are more particularly intended to be used in the production of tablets, multi-particulate foodstuffs, hard gelatin capsules, dry syrups or, alternatively, drinkable suspensions, either as they are or after certain modifications such as the addition of one or more layers of coating for example.

International application WO 98/44911 describes an extruder of the kind in question.

That extruder comprises the conventional constituent parts of any extruder and comprises, at the exit from the extrusion die, a rotary tool intended to cut the extruded profile, rod or filament and equipped with cutters the shape characteristics of which make it possible, directly and without an additional spheronization step, to obtain particles having a mean roundness index which is good but remains inferior to that of particles obtained after the conventional spheronization step.

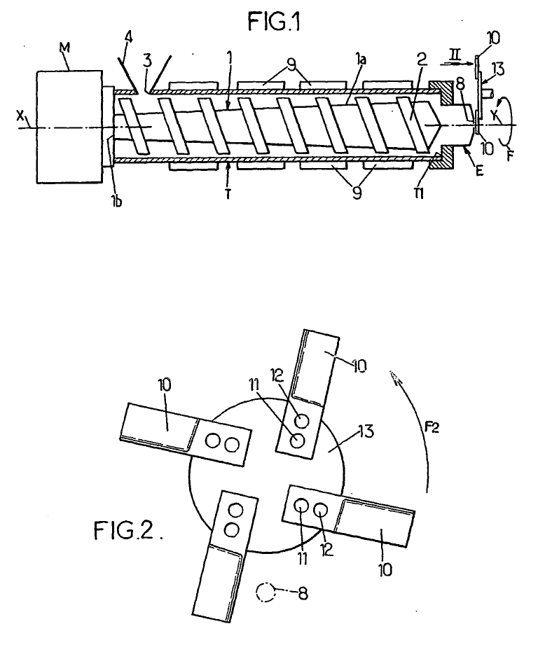

The make-up of the cutters equipping the cutting tool that the extruder comprises is evident from FIGS. 1 and 2 of international application WO 98/44911.

These cutters are in the form of a rectangular blade comprising a first and a second plane face, which are parallel to one another; this blade, which is intended to be fixed on the cutting tool by fixing means provided at one of its ends, is arranged at the other end in the form of an actual cutter by virtue of a recess provided on one of its two faces, this recess affecting only part of the face in question in such a way that on one of the long sides of this face there remains a narrow lip of a width smaller than 2 mm which is parallel to the other long side of the blade the two faces of which are connected by an inclined surface extending between the non-hollowed face and the narrow lip, of which the edge which forms a cutting edge and which constitutes one of the long sides of the blade serves to cut the extruded profile.

It will also be recalled that the roundness index which allows the roundness of a particle to be assessed consists of the ratio of the area of the two-dimensional projection of the particle obtained after cutting to the area of the projection of a perfect sphere of a diameter equivalent to the largest diameter of the particle obtained after cutting; the closer the roundness index is to 1, the closer the overall shape of the particle is to that of a sphere.

Furthermore, the higher the mean roundness index of a population of spheroids, that is to say the closer this is to 1, the more satisfactory are the flow qualities of the spheroids of the population in question and, as a result, the more satisfactorily they can be handled in packaging apparatus.

Likewise, the ability of the spheroids of a population of spheroids to accept a coating, that is to say the effectiveness of the operation of coating such a population of spheroids and the resulting gain in terms of the amount of coating substance deposited, is all the greater as the mean roundness index approaches 1.

It is therefore, above all, an object of the invention to produce an extruder of the kind in question which is able, directly and without an additional spheronization step, to produce spheroids, the mean roundness index of which is greater than that of the spheroids obtained with the extruders of the kind in question which already exist and which, in any event, is higher than 0.90, preferably higher than 0.95.

Further, it is to the credit of the Applicant Company that they have, surprisingly and unexpectedly, found that this object was achieved if an extruder of the kind described in international application WO 98/44911 was made to comprise an extrusion die of frustoconical shape.

As a result, the extruder according to the invention, which is equipped with a cutting tool identical or equivalent to that of the extruder according to international application WO 98/44911, is characterized in that it comprises an extrusion die of frustoconical shape.

More specifically, the extruder according to the invention comprises

on the one hand, a cutting tool equipped with cutters which are in the form of a rectangular blade comprising a first and a second plane face and which are parallel to one another, this blade, which is intended to be fixed on the cutting tool by fixing means provided at one of its ends, being arranged at the other end in the form of an actual cutter by virtue of a recess provided on one of its two faces, this recess affecting only part of the face in question in such a way that on one of the long sides of this face there remains a narrow lip of a width smaller than 2 mm which is parallel to the other long side of the blade the two faces of which are connected by an inclined surface extending between the non-hollowed face and the narrow lip, the edge of the narrow lip forming a cutting edge and constituting one of the long sides of the blade serves to cut the extruded profile, and

on the other hand, an extrusion die of frustoconical shape.

According to a preferred embodiment of the extruder according to the invention, the frustoconical extrusion die has a cone angle a, which ranges from 10 to 45 degrees, preferably from 20 to 30 degrees, and more preferably still is close to 24 degrees, that is to say lies between 23.5 and 24.5 degrees, it being understood that the cone angle is the angle formed between, on the one hand, a plane perpendicular to the axis of the die and, on the other hand, the inclined surface of the conical part thereof.

The invention is also aimed at other measures which are preferably used in conjunction with the foregoing and which are dealt with more explicitly in the description which follows, which targets some preferred embodiments illustrated by the drawings in which

FIG. 1 shows, in partial schematic axial section, an extruder arranged according to the invention,

FIG. 2 is a plan view on II of FIG. 1,

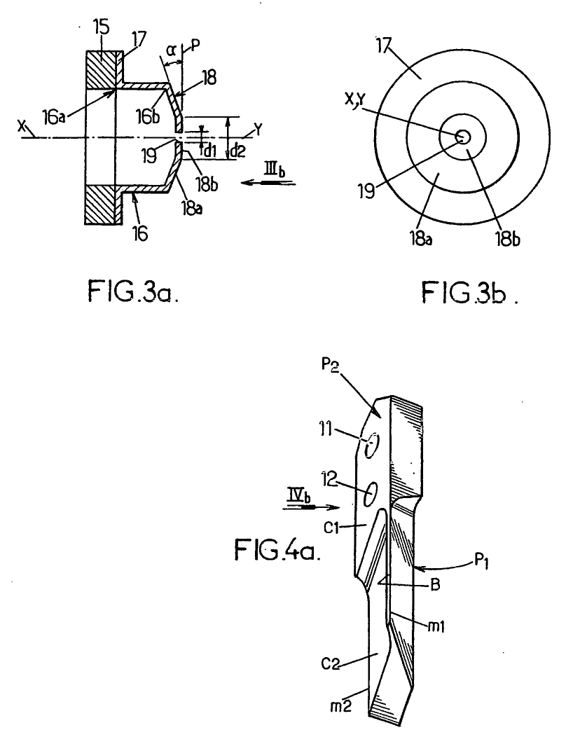

FIGS. 3a and 3b show respectively in axial section and in an end-on view on IIIb of FIG. 3a the extrusion die that the extruder comprises, and

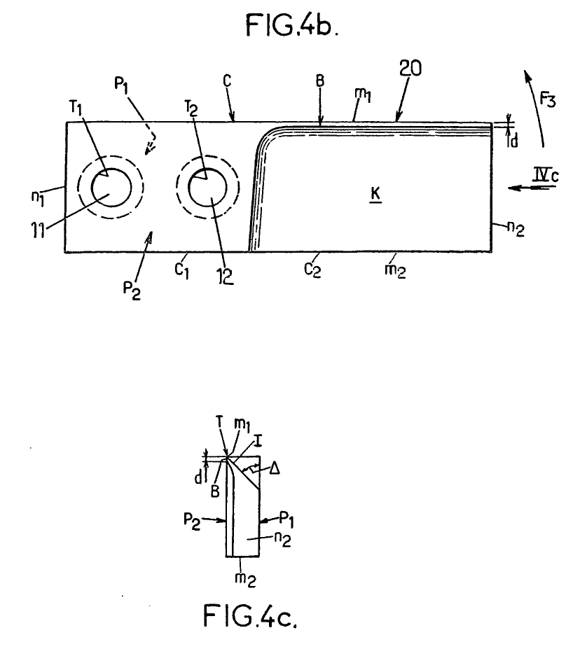

FIGS. 4a, 4b and 4c show respectively in perspective, in a plan view on IVb of FIG. 4a, and in an end-on view on IVc of FIG. 4b, one of the cutters that the cutting tool of the extruder according to the invention comprises.

First of all, it will be recalled that the manufacture of particles by extruding semi-solid blends and subsequent cutting of the profile, rod or filament leaving the extrusion die is commonly used in the pharmaceutical and agri-foodstuffs industries, the particles thus obtained being intended for the production of drugs and multi-particulate foodstuffs.

This technique makes it possible, from a semi-solid and therefore malleable blend of several ingredients, to obtain particles of homogeneous constitution, the shape of which depends in particular on the rate at which the blend is extruded, on the frequency at which the extruded blend is cut, and on the nature of the cutting tool.

In the case of “wet” extrusion, the blend to be extruded is in semi-solid form at ambient temperature.

In the case of “hot” extrusion, the blend to be extruded contains at least one thermoformable or thermoplastic ingredient, that is to say one capable of changing into a semi-solid form under the action of heat.

Both in “wet” extrusion and in “hot” extrusion, the soft material is extruded under the action of an extruder screw driving the blend through an extrusion die; the latter is made up of a metal component comprising an orifice through which the semi-solid soft material is expelled. The cutting into particles is performed at the exit of the extrusion die by a cutting tool.

This then yields a collection or population of particles, which in this application will be said to exhibit a monomodal size distribution when 95% of the particles have a size contained in an interval ranging from 95 to 105% about the mean size value of this population of particles.

That being the case, FIG. 1 shows an extruder according to the invention, essentially consisting of a tubular element of axis XY designated overall as T, inside which there is housed an endless screw 1, also of axis XY, with a conical core la and a helical flight 2; the endless screw 1 is supported by a motor M which is able to drive it in rotation in the direction of the arrow F. At the end 1b of the conical core la via which end this core is mounted on the motor M and supported thereby, the tubular element T comprises an orifice 3 surmounted by a hopper 4 via which the inside of the tubular element can be fed with material, for example thermoplastic, not depicted, intended to be extruded.

At its end T1, the tubular element comprises a frustoconical extrusion die according to the invention, denoted overall as E; this die comprises an orifice 8 of axis XY, through which the wet or thermoformable material is extruded, which material fills, inside the tubular element T, the space lying between said tubular element and the endless screw of conical core the rotation of which drives the wet or thermoformable blend toward the extrusion die and thus subjects it to a pressure that increases as it is conveyed toward the extrusion die because of the increasingly confined space available to it as a result of the conical shape of the core of the endless screw.

Temperature regulating means 9, which may consist of heating collars, are arranged on the outer surface of the tubular element so that it becomes possible to impose a predetermined temperature on the blend that is to be extruded at each point in its journey along the inside of the tubular element T.

A rotary cutting tool with four cutters 10, which are fixed on a mounting plate 13, is arranged at the exit of the extrusion die and cuts the profile, rod or filament leaving the die into successive particles. The distance between the outlet orifice of the die and the plane in which the cutters 10 move is less than 5 mm, preferably lies between 0.01 and 1.5 mm and more preferably still is close to 0.1 mm.

The location and arrangement of the cutting tool are more clearly apparent from FIG. 2 which shows one embodiment thereof with four cutters 10, these cutters being mounted by means of screws 11 and 12 on a rotary mounting plate 13 of axis ZZ′ parallel to the axis XY of the extruder, only the orifice 8 of the extrusion die E of which is shown. The mounting plate 13 is driven in rotation in the direction of the arrow F2 by drive means, not shown.

It should be emphasized that the extruder, only the orifice 8 of the die E of which is shown, is arranged above the plane in which the mounting plate 13 is situated; the extruded profile that is to be cut therefore arrives from above with respect to the plane containing the mounting plate 13.

The extrusion die E is shown in greater detail in FIGS. 3a and 3b.

It is made up, as visible in FIG. 3a, of an annular component 15 and of a cylindrical cap 16 of axis XY one of the ends 16a of which comprises a circular flange 17 via which the cap is pressed against the component 15 and the other end 16b of which is closed by a frustoconical wall 18 made up of a conical part 18a and of a plane part 18b of diameter d2 which, at its center, comprises an orifice 19 of diameter d1 centered on the axis XY, the conical part 18a making the cone angle α with a plane P perpendicular to the axis XY, as shown.

The value of the cone angle α was already given above. The value of d1 is from 0.1 to 2 mm, preferably lies between 0.6 and 0.9 mm, and more preferably still is close to 0.75 mm.

The value of d2 ranges from 2.5 to 10 mm and is preferably close to 5 mm.

The plan view of FIG. 3b again shows some of the constituent parts of the extrusion die as shown in FIG. 3a.

The characteristics of the cutters 10 are evident from FIGS. 4a, 4b and 4c.

As shown in FIGS. 4a and 4b, the cutter 10, which is in the form of a blade with two plane faces P1 and P2 parallel to one another, is of rectangular overall shape, and its two long sides are denoted m1 and m2, the two short sides being denoted n1 and n2.

This cutter comprises:

a solid part C1 via which the cutter is fixed to the cutting tool, not shown, for example by screws 11, 12 to house which two tapped holes T1 and T2 have been provided, and

a part C2 comprising, on the face P2, a recess K arranged from the long side m2 toward the long side m1 which comprises a cutting part or cutting edge 20 of the cutter as far as a distance d from this side m1, d being shorter than 2 mm, so that the surface of the cutter, which is represented by the face P2 of the part C1, extends, at the part C2, along the side m1 in the form of a narrow lip B of width d.

The recessed shape of the part C2, the cutting edge 20 comprised by the side m1 and the lip B of width d are clearly visible in FIGS. 4c and 4a.

The direction in which the cutter travels as the cutting tool rotates is shown by the arrow F3 in FIG. 4b. It should be pointed out that the profile, rod or filament that is to be cut into successive particles after extrusion moves toward the plane in which the cutter 10 moves by making its way toward this plane from the orifice of the extrusion die situated above this plane.

As a result, as the cutting tool rotates, the cutter 10 strikes the filament (not shown, leaving the die, not shown) via the cutting edge 20 and thus causes the filament to be cut into successive particles.

The precise value of d is determined according to the diameter of the hole of the die and to the speed with which the extruded filament leaves the latter, the relationship between these parameters being determined on a case-by-case basis.

The value of the angle Δ, visible in FIG. 4c and formed between the surface P1 of the plane part of C2 and the inclined part I, also known as the cutting angle, ranges from 30 to 65 degrees, preferably lies between 45 and 50 degrees.

One of the advantages of the invention lies in the fact that it is possible to easily adapt it to suit the apparatus conventionally used in the field of extrusion. This is because the essential characteristics of the invention lie in the use of a die of frustoconical shape and cutters of hollowed-out geometry described hereinabove, which can easily be fitted to any existing extruder.

The blend that is to be extruded may contain a plurality of excipients and active ingredients; it needs to be in semi-solid form, that is to say it needs to be plastically modelable as it passes through the extrusion die.

As already mentioned above, the extruder according to the invention can be used equally well in the context of the “hot extrusion” method and in the context of the “wet extrusion” method, in which the action of heat is not needed in order to give the blend that is to be extruded the required plastic qualities.

In hot extrusion, the blend that is to be extruded, which contains a thermoformable ingredient, is heated to a temperature close to the glass transition temperature of the thermoformable ingredient and is conveyed in semi-solid form as far as the extrusion die which it leaves in the form of a profile which is chopped into successive particles. Such an approach entails recourse to means for measuring and controlling the temperature of the blend progressing along the extruder screw so that said blend is in a physical state suited not only to homogeneous extrusion but also to clean cutting.

The means in question may, for example, comprise one or more thermocouples able to measure the temperature of the blend throughout its progression along the extruder screw.

The blend may, for example, be heated by means of one or more heating collars arranged around the tubular element T or plasticizing cylinder surrounding the extruder screw.

The largest dimension of the spheroidal particles obtained using the extruder according to the invention is generally from 0.1 to 2 mm.

This dimension is dependent on the rotational speed of the shaft of the extruder screw and also, in the case of “hot extrusion”, on the temperature gradient in the extrusion region, on the temperature and on the dimensions of the die. The rotational speed of the endless screw is preferably from 1 to 90 revolutions per minute. The temperature gradient in the extrusion region and the temperature of the die preferably lie in a range from 10 to 200° C.

The rotational speed of the cutting tool is fixed according to the speed at which the extrudate leaves the orifice of the die; as a preference, it is 40 to 6000 revolutions per minute.

The so-called thermoformable excipient which is solid at ambient temperature is converted through heating into a semi-solid form.

Substances belonging to the family of methacrylic polymers, such as the excipients marketed under the trade name Eudragit® for example, defined in greater detail hereinbelow, may be used as thermoformable excipients.

Preferably, the products identified hereinafter may be used as thermoformable excipient, namely

Eudragit RD100, which is a blend of sodium carboxymethylcellulose, poly(ethyl acrylate), and trimethylammonioethyl methacrylate chloride in proportions of 1:2:0.2,

Eudragit E100, which is a blend of poly(butyl)methacrylate, (2-dimethylaminoethyl)methacrylate and methyl methacrylate in proportions of 1:2:1,

Eudragit RL100, which is a blend of poly(ethyl)acrylate, methyl methacrylate and trimethylammonioethyl methacrylate chloride in proportions of 1:2:0.2, and

Eudragit RS100, which is a blend of poly(ethyl)acrylate, methyl methacrylate and trimethylammonioethyl methacrylate chloride in proportions of 1:2:0.1.

It is also possible to use, as thermoformable excipients, certain cellulose derivatives such as ethyl cellulose, hydroxypropyl cellulose, hydroxyethyl cellulose, hydroxypropylmethyl cellulose or hydroxy-methyl cellulose, hydroxypropylmethyl cellulose phthalate, cellulose acetate, cellulose phthalate acetate or alternatively microcrystalline cellulose.

Finally, use may be made, as thermoformable excipients, vinyl derivatives of the vinyl polymer type such as polyvinylpyrrolidone or PVP, crospovidone or alternatively compounds belonging to the polyethyleneglycol family, particularly PEG 6000 or PEG 8000.

### EXAMPLE 1

This is a comparative example.

The shape characteristics of particles based on diclofenac sodium obtained using a SCAMIA AF 186 extruder equipped, for four successive experiments,

with a conventional extrusion die and conventional cutters (experiment a),

with a conventional extrusion die and cutters used according to the invention (experiment b),

with a frustoconical extrusion die according to the invention and conventional cutters (experiment c),

with a frustoconical extrusion die according to the invention and cutters used according to the invention (experiment d) were compared.

The composition of the extruded blend based on diclofenac sodium is shown in Table 1.

TABLE 1

| Ingredient | wt % | Function |
|---|---|---|
| Diclofenac sodium | 50 | Active ingredient |
| Ethyl cellulose | 35 | Thermoformable |
| N 10 | | hydrophobic polymer |
| Triethyl citrate | 5 | Plasticizer |
| Stearyl alcohol | 10 | Hardener |

The diclofenac sodium and the ethyl cellulose were screened beforehand on a 1 mm screen to eliminate lumps. The stearyl alcohol was ground using a IKA type M20 cutting mill for 10 seconds and then screened on a 1 mm screen.

The diclofenac sodium, the ethyl cellulose and the stearyl alcohol were introduced into the vessel of a CONTESSO plowshare mixer and mixed for 5 min at 20 revolutions.min⁻¹.

Next, using a peristaltic pump, the triethyl citrate was gradually incorporated into the blend while the latter was still being agitated, the speed of the peristaltic pump being kept constant at 10 revolutions.min⁻¹.

In each of experiments a to d, the blend thus obtained was introduced manually or using an “endless” screw into the feed zone of the extruder.

The blend tends to soften under the action of the temperature and pressure imposed by the extrusion process.

In each of experiments a to d, the blend was profiled as it passed through the die and the extrudate thus obtained was cut using the cutting tool also known as a cutter granulator.

The technical characteristics of the extruder are shown in Table 2.

TABLE 2

| | |
|---|---|
| Diameter of the endless | 25 mm |
| extruder screw | |
| Length of the tubular | 500 mm |
| element of the | |
| plasticizing cylinder | |
| Number and location of | 4 on the plasticizing cylinder, |
| the heating collars | 1 on the die holder |
| Number and location | 2 with measurement at the |
| of the thermocouples | plasticizing cylinder |
| | (middle and end) |
| | 1 with measurement at the die holder |
| Pressure measurement | 1 with measurement at the |
| probe within the | plasticizing cylinder experiment |
| plasticizing cylinder | on the expressing die side |

Table 3 collates the operating conditions employed during the extrusion-cutting operations performed on the above-described blend.

TABLE 3

| | | |
|---|---|---|
| Rotational speed of the | 25 | revolutions · min⁻¹ |
| extruder screw | | |
| Temperature inside the | 125° | C. |
| plasticizing cylinder | | |
| Temperature at the die | 175° | C. |
| holder | | |
| Rotational speed of the | 2400 | revolutions · min⁻¹ |
| cutting tool | | |
| Cutters - die distance | 0.1 | mm |

The conventional or “flat” die used in experiments a and b had a circular outlet orifice of a diameter of 750 μm.

The die of frustoconical shape according to the invention (experiments c and d) had the following characteristics:

the diameter of the outlet orifice was 750 μm,

the diameter of the plane part of the cone frustum was 5 mm, and

the angle α characterizing the cone angle of the die was 24 degrees.

The conventional cutters used in experiments a to c differ from the cutters employed according to the invention in experiments b and d in that they have no recessed region; more specifically, the cutters used according to the invention in experiments b and d had the shape resulting from FIGS. 4a, 4b and 4c.

The shape of the particles obtained in these four experiments was determined by visual observation and classified into four categories: chips, cylinders, ovoids and spheroids.

The roundness index and the mean diameter of the particles were measured using an OLYMPUS microscope with the aid of the “Ellix” software marketed by MICROVISION over a population of 50 particles, considered to be representative.

The results obtained from the four experiments in question are collected in Table 4.

TABLE 4

| | | | Shape of the | | Mean diameter |
|---|---|---|---|---|---|
| Experiment | | | particles | Roundness | (μm) of the |
| no. | Extruder equipment | | obtained | index | particles |
| a | Conventional | Conventional | Cylinder | 0.65 ± 0.16 | 1256 ± 342 |
| | die | cutters | | | |
| b | Conventional | Cutters | Ovoid | 0.89 ± 0.11 | 855 ± 136 |
| | die | according to | | | |
| | | the invention | | | |
| c | Frustoconical | Conventional | Chip | 0.69 ± 0.16 | 717 ± 270 |
| | die | cutters | | | |
| d | Frustoconical | Cutters | Spheroid | 0.97 ± 0.03 | 751 ± 48 |
| | die | according to | | | |
| | | the invention | | | |

The improvement obtained by virtue of the invention is clearly apparent when comparing experiments b and d.

### EXAMPLE 2

Spheroids based on Fenofibrate were prepared.

The composition of the extruded blend based on Fenofibrate is shown in Table 5.

TABLE 5

| Ingredient | wt % | Function |
|---|---|---|
| Fenofibrate | 15 | Active ingredient |
| Eudragit RD 100 | 85 | Thermoformable polymer |

The Fenofibrate and the Eudragit RD 100 were introduced into a container then mixed using a horizontal mixer with multiple axes of revolution of the TURBULA make, for 10 minutes at 30 revolutions.min⁻¹.

The blend thus obtained was introduced manually or using an endless screw into the feed zone of the extruder used in example 1 which comprised the die and the cutters used in experiment d.

The operating conditions employed during the extrusion-cutting operations performed on the Fenofibrate-based blend are collated in Table 6.

TABLE 6

| | | |
|---|---|---|
| Rotational speed of the | 25 | revolutions · min⁻¹ |
| extruder screw | | |
| Temperature inside the | 100° | C. |
| plasticizing cylinder | | |
| Temperature at the die | 110° | C. |
| holder | | |
| Rotational speed of the | 600 | revolutions · min⁻¹ |
| cutting tool | | |
| Cutters - die distance | 0.1 | mm |

The roundness index and the mean diameter of the particles obtained were measured as indicated in example 1 and the results obtained are collated in Table 7.

TABLE 7

| Shape of the | Roundness | Mean diameter |
|---|---|---|
| particles obtained | index | (μm) of the particles |
| Spheroid | 0.97 ± 0.3 | 106 ± 57 |

The result is excellent, the particles obtained being practically spherical.

1-5. (canceled)

6. An extruder comprising
on the one hand, a cutting tool equipped with cutters which are in the form of a rectangular blade comprising a first and a second plane face and which are parallel to one another, this blade, which is intended to be fixed on the cutting tool by fixing means provided at one of its ends, being arranged at the other end in the form of an actual cutter by virtue of a recess provided on one of its two faces, this recess affecting only part of the face in question in such a way that on one of the long sides of this face there remains a narrow lip of a width smaller than 2 mm which is parallel to the other long side of the blade the two faces of which are connected by an inclined surface extending between the non-hollowed face and the narrow lip, of which the edge which forms a cutting edge and which constitutes one of the lone sides of the blade serves to cut the extruded profile, and
on the other hand, an extrusion die of frustoconical shape.

7. The extruder as claimed in claim 6, in which the frustoconical extrusion die has a cone angle a, which ranges from 10 to 45 degrees, preferably from 20 to 30 degrees, and more preferably still is close to 24 degrees, that is to say lies between 23.5 and 24.5 degrees.

8. The extruder as claimed in claim 6, in which the extrusion die is made up of an annular component and of a cylindrical cap of the axis one of the ends of which comprises a circular flange via which the cap is pressed against the component and the other end of which is closed by a frustoconical wall made up of a conical part and of a plane part of diameter which, at its center, comprises an orifice of diameter centered on the axis, the conical part making an angle α with a plane perpendicular to the axis.

9. The extruder as claimed in claim 7, in which the extrusion die is made up of an annular component and of a cylindrical cap of the axis one of the ends of which comprises a circular flange via which the cap is pressed against the component and the other end of which is closed by a frustoconical wall made up of a conical part and of a plane part of diameter which, at its center, comprises an orifice of diameter centered on the axis, the conical part making an angle a with a plane perpendicular to the axis.

10. The extruder as claimed in claim 6, in which the cutters have a cutting angle Δ, formed between the surface of the plane part and the inclined part and which ranges from 30 to 65 degrees, and preferable lies between 45 and 50 degrees.

11. The extruder as claimed in claim 7, in which the cutters have a cutting angle Δ, formed between the surface of the plane part and the inclined part and which ranges from 30 to 65 degrees, and preferable lies between 45 and 50 degrees.

12. The extruder as claimed in claim 8, in which the cutters have a cutting angle Δ, formed between the surface of the plane part and the inclined part and which ranges from 30 to 65 degrees, and preferable lies between 45 and 50 degrees.

13. The extruder as claimed in claim 9, in which the cutters have a cutting angle Δ, formed between the surface of the plane part and the inclined part and which ranges from 30 to 65 degrees, and preferable lies between 45 and 50 degrees.

14. The extruder as claimed in claim 6, in which the distance between the outlet orifice of the die and the plane in which the cutters move is less than 5 mm, preferable lies between 0.01 and 1.5 mm and more preferably still is close to 0.1 mm.

15. The extruder as claimed in claim 7, in which the distance between the outlet orifice of the die and the plane in which the cutters move is less than 5 mm, preferable lies between 0.01 and 1.5 mm and more preferably still is close to 0.1 mm.

16. The extruder as claimed in claim 8, in which the distance between the outlet orifice of the die and the plane in which the cutters move is less than 5 mm, preferable lies between 0.01 and 1.5 mm and more preferably still is close to 0.1 mm.

17. The extruder as claimed in claim 9, in which the distance between the outlet orifice of the die and the plane in which the cutters move is less than 5 mm, preferable lies between 0.01 and 1.5 mm and more preferably still is close to 0.1 mm.

18. The extruder as claimed in claim 10, in which the distance between the outlet orifice of the die and the plane in which the cutters move is less than 5 mm, preferable lies between 0.01 and 1.5 mm and more preferably still is close to 0.1 mm.

19. The extruder as claimed in claim 11, in which the distance between the outlet orifice of the die and the plane in which the cutters move is less than 5 mm, preferable lies between 0.01 and 1.5 mm and more preferably still is close to 0.1 mm.

20. The extruder as claimed in claim 12, in which the distance between the outlet orifice of the die and the plane in which the cutters move is less than 5 mm, preferable lies between 0.01 and 1.5 mm and more preferably still is close to 0.1 mm.

21. The extruder as claimed in claim 13, in which the distance between the outlet orifice of the die and the plane in which the cutters move is less than 5 mm, preferable lies between 0.01 and 1.5 mm and more preferably still is close to 0.1 mm.
